(19) United States
(12) Patent Application Publication
(10) Pub. No.: US 2003/0139308 A1
(43) Pub. Date: Jul. 24, 2003

(54) Composition for removing and preventing deposits on mineral surfaces

(76) Inventors: Ariane Wetzel, Frankfurt (DE); Britta Iven, Wiesbaden (DE)

Correspondence Address: ProPat, L.L.C., 2912 Crosby Road, Charlotte, NC, 28211-2815, US

(21) Appl. No.: 10/338,456

(22) Filed: Jan. 8, 2003

(30) Foreign Application Priority Data
Jan. 22, 2002 (DE) 102 02 167.8

(51) Int. Cl. C11D 1/00

(52) U.S. Cl. 510/240; 510/477

(57) ABSTRACT

Aqueous solutions of alkali metal or alkaline earth metal salts of sorbic acid, in particular of potassium sorbate, are highly suitable for the environmentally friendly removal or prevention of deposits on mineral surfaces such as stone, ceramics, concrete or mortar surfaces, which occur on these surfaces due to or as the consequence of algal growth.

### BACKGROUND OF THE INVENTION

Mineral surfaces in a moist atmosphere, such as, for example stone, ceramics or surfaces of concrete or mortar, may become covered in a wide variety of substances. This includes in particular also colonization by, or the occurrence of, cryptogams, such as, for example, algae, mosses, lichens and fungi. Given suitable conditions, these types of organisms can colonize a wide range of stones and surfaces and result in unattractive deposits.

The first step of such a colonization is usually algal growth. As autotrophic organisms, algae only require a certain amount of light and a permanently humid environment in order to grow. These conditions prevail on porous mineral surfaces. It is generally known that for example stones in gardens, in particular in shady gardens, are very rapidly covered in algae. Algal growth is also found on the surface (facade) of detached buildings, in particular at those places which receive little sun or none at all.

The deposits formed by, or containing, algae are green, at least to start with, and this alone can adversely affect the visual appearance of the surfaces in question. As a rule, these deposits are not entirely smooth, so that dirt particles such as, for example, soot particles become attached readily thereon. As a consequence, the deposits rapidly turn gray to black and thus make the surfaces in question visually very unattractive indeed. After a sufficient amount of organic matter has formed and deposited as the consequence of algal growth and adhering dirt particles, the next step is the colonization by heterotrophic organisms such as lichens, mosses and fungi, which degrade the organic matter present. The resulting degradation products can attack the mineral surface and inflict permanent damage. As a rule, this results in an additional, permanent adverse effect on the visual appearance.

This type of secondary colonization is also preferably found on shady, porous, horizontal surfaces such as, for example, tennis courts, sports tracks and playgrounds, and can lead to an increased risk of accident owing to the danger of slipping, in particular in damp weather. The same applies in particular to paved paths.

While such deposits on smooth surfaces can sometimes be removed mechanically with relative ease, this task becomes more difficult when the surface is rough and uneven. Mechanical removal of the deposits on such surfaces is difficult, and the task is frequently either unsuccessful or successful only to such an extent that the pleasing visual appearance of the surface is reinstated. Whatever the case, when these organisms have previously not been destroyed, or removed, completely, remaining residues of the original deposit rapidly grow back to form a blanket.

While detergents comprising surfactants can facilitate the removal of such deposits, experience has shown that they are only useful for smooth surfaces. In the case of rough surfaces, their action remains, as a rule, unsatisfactory.

Removing these deposits on stone can be difficult for a wide range of reasons. In the case of smooth surfaces, which are the easiest to clean mechanically, intensive working entails a risk of scratch marks. In the long term, they adversely affect the surface luster and increase the susceptibility to the renewed establishment of a deposit. In the case of stone which is chemically not fully resistant, such as, for example, calcareous stone, in particular marble, there is a risk that aggressive detergents attack the stone as such and either damage the surface or loosen its integrity. This applies in particular to detergents with a low pH.

Undesired algal growth may also occur in basins which are filled with water, for example garden ponds, bird baths and in swimming pools, in particular open-air swimming pools. Mechanical removal of the deposit from the walls and edges of the basin is in most cases only possible after the water has been drained, and, accordingly, complicated. In some of these applications, chemical additives to the water are out of the question, in particular when wild animals such as birds or else domestic animals or children have access to the water. Again, it may therefore be necessary to removal algal deposits quickly and without high outlay and without the risk of residues that may be harmful to health.

A wide range of compositions which, as a rule, comprise constituents with a detergent action and in some cases also biocidal active ingredients are on the market for removing algae and deposits of complex composition which have formed as the consequence of algal growth. The effect of these compositions is frequently unsatisfactory. In addition, they are acidic in many cases and are therefore not suitable for stone which is susceptible to acids, such as limestone.

As a result, it can be seen that the simple, satisfactory removal of algae and of deposits containing algae, in particular from stone, has not been possible to date.

The object of the present invention was therefore mainly to provide a composition for removing and/or preventing deposits as occur in particular as a consequence of, or following, algal growth on surfaces of any type. In particular, these take the form of the mineral surfaces mentioned at the outset, more preferably stone surfaces in the widest sense.

### BRIEF DESCRIPTION OF THE INVENTION

Surprisingly, it has been found that aqueous solutions of sorbates, in particular of potassium sorbate, permit simple and rapid removal not only of deposits consisting purely of algae, but also of older deposits which are based on algae and which additionally contain dirt and have become covered in various substances. What is particularly surprising about this effect is that no further agents are required and that, after allowing these solutions to act for a brief period, the deposits can be removed simply by mechanical means without applying forces or conditions which would damage smooth or sensitive surfaces.

### DETAILED DESCRIPTION OF THE INVENTION

Thus, the present invention encompasses firstly the use of sorbic acid or its salts, in particular the use of alkali metal or alkaline earth metal salts of sorbic acid, for removing and/or preventing the abovementioned deposits.

Furthermore, the invention encompasses compositions, preferably aqueous compositions, which comprise the abovementioned salts and which serve for the abovementioned purpose, and a method for removing and/or preventing the above-described deposits using these compositions.

Preference is given to those salts of sorbic acid which are readily soluble in water, i.e. the alkali metal salts, and among those in particular the sodium or potassium salt, in particular the potassium salt (potassium sorbate).

In addition to water and a salt of sorbic acid or various salts of sorbic acid, the compositions according to the invention may also comprise further adjuvants and/or active ingredients. These are preferably substances which are used in the commercially available algicides and include biocidal active ingredients and customary organic solvents. Examples of such additional substances are found, for example, in Römpp Chemie-Lexikon [Römpp's Dictionary of Chemistry], 10th edition, p. 103, Thieme Verlag Stuttgart, under the entry Algicides. Such additional constituents are not imperative; indeed, as has been described above, they are capable of reducing the advantages according to the invention to a minimum or of eliminating them completely.

The above-described effect is particularly surprising because sorbic acid and its salts have long been employed as preservatives for foodstuffs and also for industrial purposes, and their effect against yeasts, molds and also bacteria has been studied extensively and documented. In contrast, virtually no information on an effect against algae or lichens and no proposals regarding the uses according to the invention have been available to date.

The comprehensive monograph on properties and uses of sorbic acid by Lück mentions only very briefly that no extensive studies are available in this field. The only effects which are reported are a growth-inhibitory effect against the alga Chlorella vulgaris and an effect at pH 4.4, but not at pH 6.5 (E. Lück, Sorbinsäure [Sorbic Acid], Volume II, page 56, Behr's Verlag, Hamburg, 1972).

While a limited effect against the alga Chlorella pyrenoidosa, which was also observed at pH 6.7, has been reported in another paper, this effect was far less pronounced than that of some of the other substances tested (J. Am. Chem. Oil Chem. Soc. 61, No. 12, 1984, pages 1877 to 1880).

Sorbic acid and/or its salts are usually used in concentrations of from 0.2 to not more than 0.5% by weight in foodstuffs and industrial products. It appears that no studies have been carried out to date into the use of higher concentrations, in particular in the case of algae and lichens.

It is generally known (E. Lück, Sorbinsäure, Volume II, pages 88 to 90, Behr's Verlag, Hamburg, 1972) that sorbic acid has a much better effect in acidic media than in neutral media, and that, when potassium sorbate is used, the sorbic acid released therefrom in acidic media is the actual preserving agent. Potassium sorbate has a mildly alkaline reaction and the substance per se is far less active on microorganisms than sorbic acid. It is all the more surprising that the potassium sorbate solution, which is alkaline, has a good and rapid effect in the present case even though its pH is usually around or indeed slightly above eight, and that, in addition, it does not only appear to destroy the algae, but also greatly facilitates the mechanical removal of algae and the deposits which they entail.

It is furthermore surprising that the potassium sorbate, which, as such, is readily soluble in water, penetrates slightly porous stone and is, it appears, not instantly leached out by rain or splash water, so that a certain delayed-release effect takes place and a protection against new deposits is retained for a while.

The use of aqueous solutions of salts of sorbic acid, in particular of potassium sorbate, thus represents considerable progress in the elimination of undesired deposits, in particular on mineral surfaces such as stone, and their protection against the renewed formation of such deposits.

Solutions which can preferably be employed for cleaning surfaces are aqueous potassium sorbate solutions in the range of from 5 to 40% by weight, preferably of from 10 to 20% by weight (in each case based on the finished preparation). These solutions can be prepared as required starting from solid potassium sorbate, which dissolves very rapidly and readily in water. However, they can also be prepared for stock and stored if the containers used for this purpose provide protection from light. Any substances which are additionally present are, as a rule, incorporated into these solutions/preparations by vigorous stirring.

Potassium sorbate can be handled without problems, both in the form of the solid and the aqueous solution. Even as the solid, it is barely irritating to the skin, and it does not irritate the skin in aqueous solution in the abovementioned concentration range when allowed to act on it briefly, which may be the case. Thus, it can be used without problems even by the layman. If humans, including toddlers, or animals come into contact with any residues which may remain, there is no health hazard. In addition, potassium sorbate can also be employed without problems taking into consideration the protection of the environment. If it is present at low concentration below the inhibitory limit concentration, it is metabolized by a number of live organisms in the manner of fatty acids, that is to say degraded to give water and carbon dioxide. It can be assumed that the dilution achieved with just one rinsing pass after cleaning directly leads to concentrations which are biodegradable without problems not only in the immediate environment but also in water treatment plants.

Owing to its potency against yeasts and fungi and its particularly advantageous physiological properties, potassium sorbate and the active substance sorbic acid which it contains is approved worldwide for many applications in the preservation of foodstuffs. It may thus be ingested in substantial quantities.

Solutions which are suitable for the use according to the invention are preferably aqueous solutions of sorbates, in particular of potassium sorbate, in the range of from 5 to 40% by weight, but preferably in the range of from 10 to 20% by weight. These solutions are applied to the surfaces to be treated in a suitable manner, for example by spraying on, pouring on or brushing on, until the deposit has been wetted thoroughly and evenly, and, after an exposure time tailored to suit the thickness of the deposit, the latter is removed mechanically. In the case of thin deposits on smooth areas, as little as ten minutes may suffice, while the exposure time can be extended without problems to an hour and more in the case of thick deposits on rough surfaces. In the case of smooth surfaces, it will not infrequently suffice to apply the solution with a powerful jet of water, thus eliminating the deposits in the process. Rough surfaces will additionally require mechanical means, for example using a brush or suitable mechanical cleaning equipment.

The above information regarding use and composition of the potassium-sorbate-containing compositions also applies analogously and preferably to the other sorbic acid salts to be used in accordance with the invention.

In general, the concentrations, quantities and exposure times required, of the compositions according to the invention, can be determined rapidly and reliably by simple preliminary experiments, in particular as a function of the nature of the deposit and thus the surface structure.

The invention is illustrated in greater detail by the examples which follow:

### EXAMPLE 1

Removal of an algal film on a smooth marble surface with the aid of a potassium sorbate solution

A smooth marble surface which is covered in a thin green algal deposit is sprayed uniformly with an aqueous 10% by weight strength potassium sorbate solution until the former is wetted thoroughly and uniformly. After an exposure time of 10 minutes, the surface is treated with a powerful jet of water. The algal film may be removed by the jet of water.

### EXAMPLE 2

Removal of an algal film on a smooth marble surface with the aid of a powerful jet of water without potassium sorbate

A smooth marble surface which is covered in a thin green algal deposit is sprayed uniformly with water until it is wetted thoroughly and uniformly. After an exposure time of 10 minutes, it is treated with a powerful jet of water. Apart from minor patches, the algal film remains on the surface.

### EXAMPLE 3

Removal of a green algal deposit on a rough synthetic stone surface with the aid of a potassium sorbate solution

An aqueous 10% by weight strength potassium sorbate solution is applied uniformly to rough synthetic stone covered in a green algal deposit. After an exposure time of 30 minutes, the stone is worked thoroughly and uniformly with a brush. It is then rinsed with water. During the brushing and the subsequent rinsing, the deposit is removed.

### EXAMPLE 4

Removal of a green algal deposit on a rough synthetic stone surface without potassium sorbate

Rough synthetic stone which is covered in a green algal deposit and has thus lost its visual appeal is wetted uniformly. The stone is subsequently worked thoroughly and uniformly with a brush. It is then rinsed with water. During the brushing and the subsequent rinsing, only part of the deposit is removed. The green discoloration of the stone remains.

### EXAMPLE 5

Removal of a black, algae-containing film on a rough synthetic stone surface with the aid of a potassium sorbate solution

An aqueous 20% by weight strength solution of potassium sorbate is applied uniformly to rough synthetic stone which is covered in a grayish-black deposit and has thus lost its visual appeal. After an exposure time of 30 minutes, the stone is worked thoroughly and uniformly with a brush. It is then rinsed with water. During the brushing and subsequent rinsing, the deposit is removed. The original pale-gray color of the stone appears again.

### EXAMPLE 6

Removal of a black, algae-containing film on a rough synthetic stone surface by mechanical working without potassium sorbate

Rough synthetic stone which is covered in a grayish-black deposit and has thus lost its visual appeal is wetted uniformly with water. After an exposure time of 30 minutes, the stone is worked thoroughly and uniformly with a brush. It is then rinsed with water. Only some of the deposit is removed during brushing and the subsequent rinsing. The stone retains its grayish-black color.

1. Method for removing or preventing deposits on surfaces, comprising locating a surface with one or more of sorbic acid and its salts.

2. The method as claimed in claim 1, wherein the salts are the alkali metal or alkaline earth metal salts of sorbic acid which are readily soluble in water.

3. The method as claimed in claim 2, wherein the salts are the alkali metal salts of sorbic acid which are readily soluble in water.

4. The method as claimed in claim 1, wherein the salt is potassium sorbate.

5. The method as claimed in claim 1, wherein the surfaces are mineral surfaces.

6. The method as claimed in claim 5, wherein the surfaces are the surfaces of stone, ceramics, concrete or mortar.

7. The method as claimed in claim 1, wherein the deposits are those formed by or as a consequence of the colonization or occurrence of cryptogams on these surfaces.

8. A composition for removing or preventing deposits on surfaces, comprising water and one or more of sorbic acid and its salts.

9. A composition as claimed in claim 8, which comprises an alkali metal or alkaline earth metal salt of sorbic acid which is readily soluble in water.

10. The composition as claimed in claim 8, wherein the salt is an alkali metal salt of sorbic acid which is readily soluble in water.

11. The composition as claimed in claim 8, which comprises potassium sorbate.

12. The composition as claimed in claim 8, which comprises one or more salts of sorbic acid at an overall concentration of about 5 to about 40, % by weight, based on the finished preparation.

13. The composition as claimed in claim 8, which comprises additional auxiliaries or active substances or auxiliaries and active substances.
